(19) United States
(12) Patent Application Publication
(10) Pub. No.: US 2025/0173556 A1
(43) Pub. Date: May 29, 2025

(54) Relevance-Based Filtering Of Machine-Learning-Generated Descriptions

(71) Applicant: Oracle International Corporation, Redwood Shores, CA (US)

(72) Inventor: Karempudi V. Ramarao, San Ramon, CA (US)

(73) Assignee: Oracle International Corporation, Redwood Shores, CA (US)

(21) Appl. No.: 18/523,409

(22) Filed: Nov. 29, 2023

(51) Int. Cl. G06N 3/0475

(52) U.S. Cl. CPC G06N 3/0475

(57) ABSTRACT

Techniques for generating filtered description content based on seed statements are disclosed. A system filters a set of descriptive sentences based on a relevance of the sentences to a seed statement. The system creates a set of input segments from the seed statement. The system creates a set of output segments from the set of descriptive sentences. The system generates a set of relevance scores for each input segment/output segment pair. The system compares the relevance scores to a set of relevance criteria to generate a filtered set of descriptive sentences.

### TECHNICAL FIELD

The present disclosure relates to filtering machine-learning-generated descriptions based on a relevance of description components to seed statement components. In particular, the present disclosure relates to filtering content from ML-generated descriptions based on a relevance of sentences within the descriptions to sub-components of a seed statement used to generate the description.

### BACKGROUND

Large language models (LLMs) are a type of machine learning model capable of generating text content from short prompts. For example, providing an LLM with a prompt to “write a paragraph about Henry V” results in a multi-sentence paragraph describing the historical figure Henry V. One known shortcoming of LLM models and other generative artificial intelligence (AI) type machine learning models is a tendency to “hallucinate.” Generative AI models are trained to learn how to order text based on training documents, not to identify truth or error. Accordingly, generative AI models sometimes generate content that is not true in response to prompts.

In addition, organizations seeking to utilize LLMs to generate content, such as content for a website, may find that the length, semantic content, and context within a set of generated text does not meet a set of specifications for the organization. For example, an LLM may generate a paragraph of five sentences in which three of the sentences are not relevant to the organization. In addition, the content may be too short or too long to be used by the organization without modification.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for generating and modifying text content from seed statements using relevance scoring in accordance with one or more embodiments;

FIGS. 3A-3D illustrate an example embodiment; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present invention.
1. GENERAL OVERVIEW
2. SYSTEM ARCHITECTURE
3. GENERATING FILTERED DESCRIPTION CONTENT FROM SEED STATEMENTS
4. EXAMPLE EMBODIMENT
5. COMPUTER NETWORKS AND CLOUD NETWORKS
6. MISCELLANEOUS; EXTENSIONS
7. HARDWARE OVERVIEW

### 1. General Overview

One or more embodiments filter a set of descriptive sentences based on the relevance of the sentences to a seed statement. A system creates a set of input segments from the seed statement. The input segments may include overlapping content. For example, a seed statement: “Entry-Level Financial Analyst” may correspond to three input segments: “Analyst,” “Financial Analyst,” and “Entry-level Financial Analyst.” The system creates a set of output segments from the set of descriptive sentences. The output segments are at least one sentence in length. In addition, the system creates at least one output segment per input segment. The system generates a set of relevance scores for each input segment/output segment pair. For example, if there are three input segments and three output segments, the system generates nine relevance scores. The system compares the relevance scores to a set of relevance criteria to generate a filtered set of descriptive sentences. For example, if the initial set of descriptive sentences included five sentences, the system may filter the sentences to a set of three sentences determined to be the most relevant to a set of three input segments of a seed statement.

One or more embodiments generate a filtered set of description content for a seed statement by performing a two-stage process of (a) applying a maximal matching algorithm to bipartite graph, and (b) determining an overall relevance for a set of maximal-matching output segments to a corresponding set of input segments. One vertex of the bipartite graph includes the input segments. The other vertex includes the output segments. The intersections of the input segments and output segments store the corresponding relevance values. The maximal matching algorithm finds the set of input segment/output segment pairs corresponding to a maximum sum of relevance values, where no input segment in the maximal match is paired with the same output segment. The system determines the overall relevance for the set of maximal-matched input segment/output segment pairs (“the maximal match”) based on one or more of the relevance values in the maximal match. For example, the system may designate the lowest relevance value among the relevance values in the maximal match as being the overall relevance value. As another example, the system may calculate an average relevance value from the set of relevance values in the maximal match. According to yet another example, the system may apply a different threshold to different input segments of the maximal match. For example, the system may classify one input segment as being the “core” input segment and other input segments as being “qualifier” input segments. The system may set a higher relevance threshold for the core input segment than for the qualifier input segments.

One or more embodiments iteratively modify one or both of the seed statements and a set of generated description content based on the analysis of the relevance of the description content to the seed statement. The iterative process may include the following: (a) segmenting the seed statement and description content, (b) generating vectors for the seed statement segments and description content segments, (c) performing a relevance analysis of seed statement content segment/description content segment pairs, (d) modifying one or both of the seed statement and the description content based on the analysis, and (c) repeating (a)-(d) until a relevance threshold is met. In one embodiment, modifying a seed statement includes replacing an original seed statement with a historical seed statement or an organization-authorized seed statement. For example, an organization may store a set of seed statements that have been used in the past to generate description content. Replacing the original seed statement may include applying a nearest-neighbor type algorithm to the original seed statement and the additional seed statements to determine, by a computer, which of the additional seed statements is the closest, semantically, to the original seed statement. Replacing the description content may include providing a sentence to an LLM with a prompt to generate a replacement sentence or set of sentences. For example, the system may generate a prompt to an LLM. The prompt includes the following elements: (a) a particular sentence that corresponds to a particular output segment and a relevance score that is below a threshold, (b) a particular input segment paired with the particular sentence in the maximal match, and (c) an instruction to modify the sentence to be more relevant to the particular input segment. In one example, the prompt further includes a weight value as metadata, representing the degree to which the LLM should modify the sentence based on a degree to which the sentence falls short of the relevance threshold.

One or more embodiments receive a user instruction, including a seed statement, to generate a set of description content based on the seed statement. A backend platform (a) applies the seed statement to a generative AI model to generate an initial set of description content, (b) segments the seed statement and description content, (c) generates vectors for the seed statement segments and description content segments, (d) performs a relevance analysis of seed statement content segment/description content segment pairs, and (c) modifies one or both of the seed statements and the description content based on the analysis. The backend platform returns the filtered and/or modified set of description content to the user in response to the user's instruction.

One or more embodiments described in this Specification and/or recited in the claims may not be included in this General Overview section.

### 2. Architectural Overview

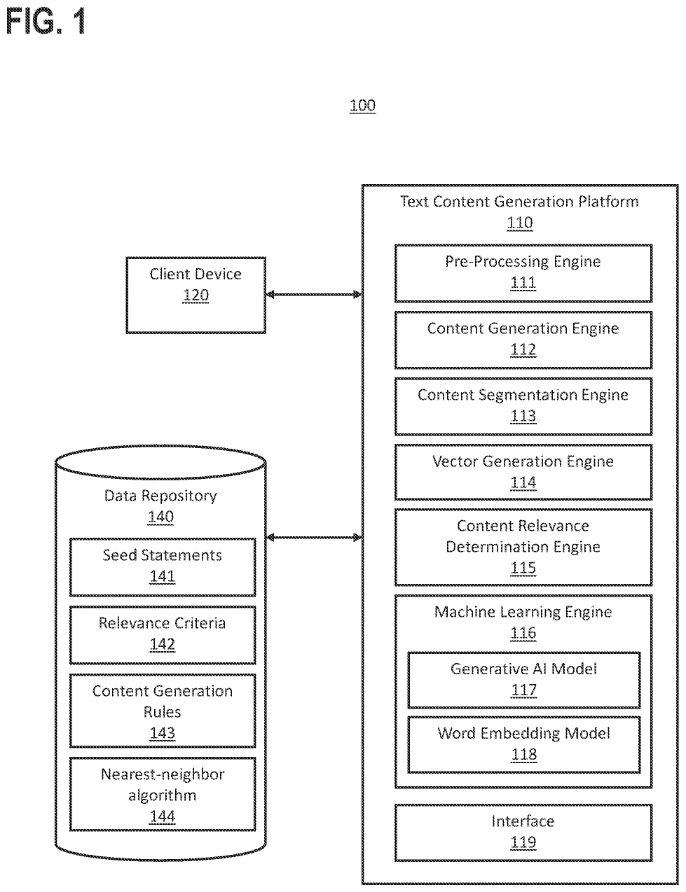

FIG. 1 illustrates a system 100 in accordance with one or more embodiments. As illustrated in FIG. 1, system 100 includes a text content generation platform 110, a client device 120, and a data repository 140. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

The text content generation platform 110 is configured to receive requests directed to a generative artificial intelligence (AI) model 117 to generate text content. The text content generation platform 110 modifies content corresponding to the requests and the generated content based on determining a relevance of generated content output from the generative AI model 117 to input content provided to the generative AI model 117.

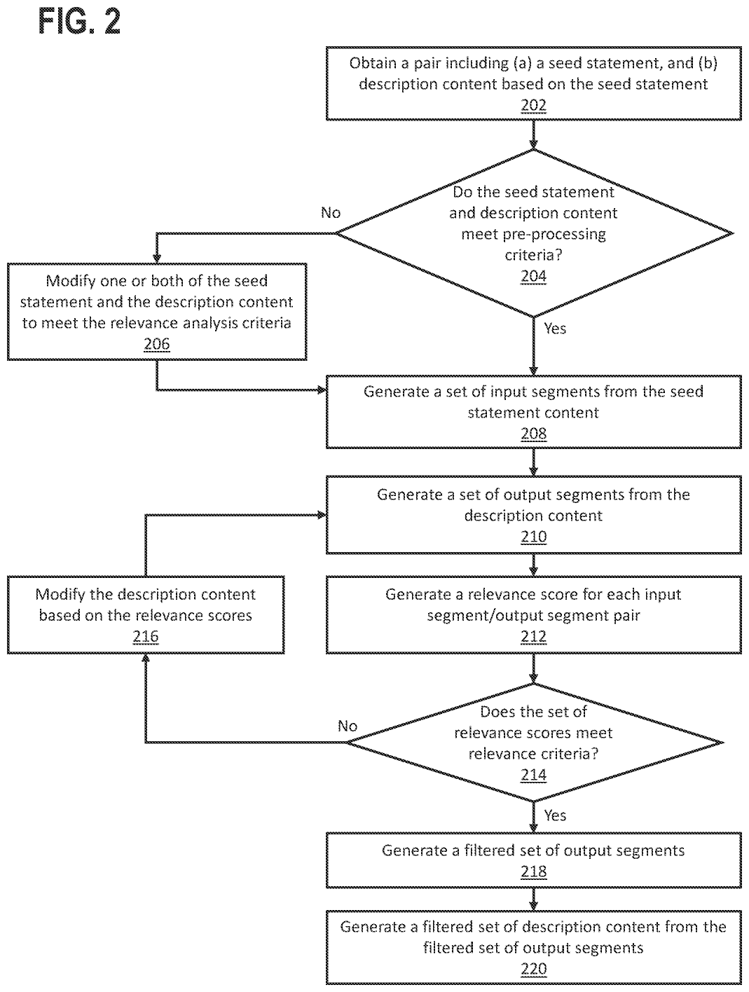

In one or more embodiments, the text content generation platform 110 refers to hardware and/or software configured to perform operations described herein for applying a maximal matching process to generate and filter descriptive content corresponding to a seed statement. Examples of operations for applying a maximal matching process to generate and filter descriptive content corresponding to a seed statement are described below with reference to FIG. 2.

In an embodiment, the text content generation platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, a data repository 140 is any type of storage unit and/or device (e.g., a file system, database, collection of tables, or any other storage mechanism) for storing data. Further, a data repository 140 may include multiple different storage units and/or devices. The multiple different storage units and/or devices may or may not be of the same type or located at the same physical site. Further, a data repository 140 may be implemented or may execute on the same computing system as the text content generation platform 110. Alternatively, or additionally, a data repository 140 may be implemented or executed on a computing system separate from the text content generation platform 110. A data repository 140 may be communicatively coupled to the text content generation platform 110 via a direct connection or via a network.

Information describing the seed statements 141, relevance criteria 142, and content generation rules 143 may be implemented across any of components within the system 100. However, this information is illustrated within the data repository 140 for purposes of clarity and explanation.

In one or more embodiments, interface 119 refers to hardware and/or software configured to facilitate communications between a user and the text content generation platform 110. Interface 119 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 119 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 119 is specified in one or more other languages, such as Java, C, or C++.

A pre-processing engine 111 performs pre-processing on a seed statement to determine whether the seed statement complies with a set of content generation rules 143. If the seed statement complies with the rules 143, the pre-processing engine 111 transmits the seed statement to a content generation engine 112. If the seed statement does not comply with the rules 143, the pre-processing engine 111 modifies the seed statement prior to transmitting the seed statement to the content generation engine 112.

For example, a seed statement may be a job title, product title, document section header, or other set of words, shorter than a sentence, that includes thematic content for generating description content. The pre-processing engine 111 may determine whether the seed statement complies with the rules 143 based on determining: a format of the seed statement is an authorized format; the words in the seed statement are included in a dictionary of authorized words; and the seed statement is among a set of authorized seed statements 141.

The content generation engine 112 generates content based on the seed statement. In one embodiment, the content generation engine 112 includes a generative AI model 117. For example, the content generation engine 112 may include a generative pre-trained transformer (GPT) large language model (LLM).

A GPT LLM model may be implemented as deep learning model which combines a deep learning technique, called attention, in combination with a deep learning model type known as “transformers”. The GPT LLM model may generate descriptive content based on seed statement content by encoding and predicting natural language writing.

According to one embodiment, the generative AI model 117, which may be implemented as the generative AI model 117, contains hundreds of billions of parameters trained on multiple terabytes of text. The generative AI model 117 is trained to receive natural language as an input. The generative AI model 117 generates natural language as an output. The generative AI model 117 is made up of layers of attention mechanisms and neural networks that process input data in parallel. The layers of attention mechanisms and neural networks operating in parallel allow the generative AI model 117 to learn complex patterns in text.

The attention mechanisms help neural networks in the generative AI model 117 to learn the context of words in the sequences of words. The attention mechanisms operate by breaking down a set of input data, such as a sentence or sequence of words or tokens, into keys, queries, and values. Keys represent elements of the input data that provide information about what to pay attention to. Queries represent elements of the input data that need to be compared with the keys to determine relevance. Values are elements of the input data that will be selected or weighted based on the attention scores. The attention mechanism calculates a similarity score between each query and key pair. This score reflects how relevant each key is to a given query. Various methods can be used to compute these scores, such as dot-product, scaled dot-product, or other custom functions. The similarity scores are then transformed into attention weights. For example, a system may transform the similarity scores using a softmax function. The softmax function adjusts the values of the similarity scores relative to each other such that the sum of the similarity scores is 1. Finally, the attention weights are used to take a weighted sum of the corresponding values. This weighted sum represents the model's focused or “attended” 3 € 8 representation of the input data. In one or more embodiments, the attention mechanisms are implemented using self-attention processes, scaled dot-product attention processes, and multi-head attention processes.

A content segmentation engine 113 generates a set of input segments from the seed statement and a set of output segments from the description content. The content segmentation engine 113 may generate input segments by (a) identifying a core word or set of words as one input segment, and (b) combining the core word(s) with one or more additional words to generate additional input segments until each word in the seed statement is incorporated into an input segment. The content segmentation engine 113 may generate output segments based on a predefined number of adjacent sentences or characters. Whereas the input segments include overlapping text content, the output segments are mutually exclusive and do not include overlapping content. According to one example, one output segment includes one sentence. If the description content include text that is not in a format of a sentence, the content segmentation engine 113 may generate an output segment based on a number of characters. Alternatively, the content segmentation engine 113 may generate an output segment by combining text that is not part of a sentence with a next consecutive sentence. According to another example, the content segmentation engine generates one output segment by incorporating the minimum number of adjacent sentences necessary such that the sum of characters in the sentence(s) equals at least a predefined number, such as 60 characters.

A vector generation engine 114 generates vectors representing the input segments and the output segments. In addition, the vector generation engine 114 may encode words in the seed statement as vectors to generate the input segments. In one embodiment, the vector generation engine 114 encodes text as vectors by applying an algorithm, such as a term frequency-inverse document frequency (TF-IDF) to generate a numerical value for each word in a seed statement. According to one or more alternative embodiments, the system may encode the text as vectors by applying a word embedding model 118, such as a Word2Vec or GloVe model. According to yet another alternative embodiment, the system may encode the text as vectors by applying a pre-trained language model, such as a Bidirectional Encoder Representations from Transformers (BERT) model, or a generative AI model 117, such as a generative pre-trained transformer (GPT) model.

A content relevance determination engine 115 generates a relevance score for each input segment/output segment pair, representing a relevance of content corresponding to the output segment to content corresponding to the input segment. The relevance score may be a similarity score based on a vector representing the input segment and a vector representing the output segment. According to one example embodiment, the content relevance determination engine 115 determines the relevance score by calculating a cosine similarity value between a vector representing an input segment and a vector representing an output segment. The content relevance determination engine 115 may calculate the cosine similarity value by applying the following formula:

Cos Similarity (A, B)=(A. B)/(∥A∥*∥B∥)

In the formula above, (A·B) represents the dot product of the two vectors, and ∥A∥ and ∥B∥ represent the magnitudes, or the Euclidean norms, of vectors A and B, respectively. The cosine similarity value may be a value that ranges from 0 to 1, where 0 indicates two values are extremely dissimilar and 1 indicates the two values are the same.

According to another example embodiment, the content relevance determination engine 115 determines the relevance score by calculating a Jaccard similarity value between a vector representing an input segment and a vector representing an output segment. The content relevance determination engine 115 may calculate the Jaccard similarity value by applying the following formula:

Jaccard Similarity (A, B)=|A∩B|/|A∪B|

In the formula above, |A∩B| represents the size of the intersection of the sets A and B, and |A∪B| represents the size of the union of the sets.

According to yet another example embodiment, the system may determine the relevance score by calculating a Euclidian distance or a Manhattan distance between a vector representing an input segment and a vector representing an output segment.

In one or more embodiments, the content relevance determination engine 115 generates a bipartite graph based on the relevance scores for each input segment/output segment pair. One vertex of the graph includes the input segments, while the other vertex of the graph includes the output segments. Intersections of the vertices store the relevance scores corresponding to the respective input segments and output segments.

The content relevance determination engine 115 determines whether the set of generated relevance scores corresponding to the pairs of input segments and output segments meets relevance criteria 142. The relevance criteria 142 may include a minimum relevance score value for each input segment. For example, the criteria may specify that the input segments must each correspond to at least one unique output segment with a relevance score for the input segment/output segment pair that exceeds a threshold.

According to one or more embodiments, the content relevance determination engine 115 applies a maximal matching algorithm to the bipartite graph to identify a set of input segment/output segment pairs in which (a) each output segment in the set is exclusive of each other output segment, and (b) a sum of relevance scores for the pairs is greater than the sum of any other relevance scores of any other sets of input segment/output segment pairs. The content relevance determination engine 115 further compares one or more relevance values in the maximal matching set of input segment/output segment pairs to a threshold to determine if the relevance scores meet the relevance criteria. According to one embodiment, the threshold includes a numerical value for the sum of relevance scores associated with the maximal matching set of input segment/output segment pairs. For example, the system may set a threshold at 1.2 for a set of three input segments. If the composite relevance score (e.g., the sum of relevance scores) corresponding to the set of input segment/output segment pairs corresponding to the maximal match meets the threshold, the content relevance determination engine 115 may determine that the set of relevance scores meets the relevance criteria. If the composite relevance score corresponding to the set of input segment/output segment pairs corresponding to the maximal match does not meet the threshold, the content relevance determination engine 115 may determine that the set of relevance scores does not satisfy the relevance criteria.

Based on determining that the relevance scores meet the relevance criteria, the content relevance determination engine 115 generates a filtered set of output segments. The text content generation platform 110 compares a set of description content corresponding to the filtered set of output segments to the set of content generation rules 143. For example, the rules may specify that a particular type of content should include a particular number of descriptive sentences for each seed statement. Alternatively, the rules may specify that a particular type of content (such as a job posting or product description) should include a certain number of sentences per input segment. In addition, or in the alternative, the set of content generation rules 143 may include grammatical rules. For example, omitting one or more sentences from the initial description content may result in text that lacks transition language or context for remaining sentences. Based on the content generation rules 143, the text content generation platform 110 may modify the filtered set of sentences to comply with the rules, such as by correcting grammatical errors or generating additional sentences. For example, the text content generation platform 110 may provide the filtered set of sentences to the generative AI model 117 with a prompt to generate an additional sentence associated with a particular input segment.

In one or more embodiments, one or both of the pre-processing engine 111 and the content relevance determination engine 115 apply a nearest-neighbor-type algorithm 144 to a set of vectors generated by the vector generation engine 114 to identify text content that is closest to a target set of text content. For example, the pre-processing engine 111 may determine that a seed statement does not meet criteria for generating description content. The seed statement may not be among an organization-approved set of seed statements. Alternatively, the seed statement may not be in an organization-approved format. In addition, or in the alternative, the content relevance determination engine 115 may determine that a set of description content associated with a particular seed statement does not satisfy a relevance threshold. Accordingly, the system may apply a nearest-neighbor-type algorithm to identify a historical seed statement 141 that is closest to the original seed statement for generating a new set of description content.

The nearest-neighbor algorithm 144 includes a sequence of operations performed by the pre-processing engine 111 and/or the content relevance determination engine 115 including (a) obtaining a vector representing a target seed statement, (b) obtaining additional vectors representing a set of authorized or historical seed statements 141, (c) calculating distances between the target vector and the additional vectors, and (d) identifying one of the additional vectors as being closest to the target vector based on the calculated distance.

In one or more embodiments, the text content generation platform 110 generates the nearest-neighbor algorithm 144 with parameters based on the types of data included in the seed statements 141 and the description content generated by the generative AI model 117. For example, based on determining that the numerical vectors representing the text content in the seed statements 141 contain continuous data, the text content generation platform 110 selects one or more of a Euclidian distance, a Manhattan distance, and a Minkowski distance to measure a distance between vectors. Based on determining that the numerical vectors, representing the text content in the seed statements 141, include at least some categorical data, the text content generation platform 110 calculates a distance between vectors using at least one of the above distance measures (e.g., Euclidian, Manhattan, and Minkowski), in combination with one or more of a Hamming distance and a Jaccard Index.

In an embodiment in which the text content generation platform 110 generates the description content based on receiving a user-generated request including the seed statement, the text content generation platform 110 sends the filtered set of description content to the client device 120 rather than sending the initially-generated description content to the user device.

Additional embodiments and/or examples relating to computer networks are described below in Section 5, titled “Computer Networks and Cloud Networks.”

### 3. Generating Filtered Description Content from Seed Statements

FIG. 2 illustrates an example set of operations for generating filtered descriptions from seed statements in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

A system obtains a set of data including a pair of (a) a seed statement, and (b) description content based on the seed statement (Operation 202). The seed statement is a set of words and/or tokens. In one embodiment, the seed statement has a length no longer than a sentence. In one or more embodiments, the seed statement is a set of words that is not a grammatically-correct sentence with a subject and verb. For example, the seed statement may be a title, such as a job title or product title. In one example, the seed statement is a job title, such as “Senior Marketing Analyst,” “Customer Relations Specialist,” or “Junior Software Engineer.” Other examples of seed statements include a document title, a section heading title in a document, and a product name. The description content is (a) thematically related to the seed statement, and (b) longer in text length than the seed statement. For example, a seed statement may have a length measurable in words, with a total length being less than a sentence. According to one or more embodiments, the seed statement is eight words or less. The description content may have a length measurable in complete sentences, each including a subject and verb. Each sentence in the description content may have a length at least equal to a length of the seed statement. In one embodiment, each sentence of the description content has a character length longer than a character length of the seed statement.

According to one embodiment, the description content is generated by a generative AI machine learning model in response to a prompt including the seed statement. For example, a system may receive a request to generate description content associated with a seed statement. The seed statement may include a set of five words. In an example in which the seed statement is a job title, the request may include a request to generate a set of sentences representing a job description for a job based on the job title.

According to one or more alternative embodiments, the system obtains the seed statement and corresponding description content based on previously-generated content. For example, an enterprise may employ a program, such as a web crawler, to analyze content on a set of web pages managed by the enterprise to identify sets of seed statements and corresponding description content. For example, the system may implement the web crawler to send hypertext transfer protocol (HTTP) requests to a set of uniform resource locators (URLs) to obtain the hypertext markup language (HTML) content of the web pages associated with the URLs. The web crawler may parse the HTML content to extract the text content, including seed statements and description content, from the HTML content. In addition, or in the alternative, a system may analyze database content to identify sets of seed statement/description content pairs stored in tables or objects in the database. Analyzing database content may include, for example, generating a query or set of queries to retrieve the seed statement/description content pairs from the database.

The system determines whether the seed statement and/or the description content meet a set of pre-processing criteria (Operation 204). In one example in which the system prompts the generative AI model with the seed statement to generate the description content, the system applies a set of rules to the seed statement prior to applying a generative AI model to the seed statement. The set of rules may specify a number and type of words that should be in the seed statement. The set of rules may specify a format in which the seed statement should be written. According to one example, the rules may specify a particular number of nouns and adjectives to be included in the seed statement. According to another example, the rules may specify particular classifications of words or phrases to be included in the seed statement. For example, the system may classify sets of words as “key words/phrases” and “descriptive words/phrases” that describe the key words and phrases. In the example in which the seed statement is a job title, the predefined format may include a set of between 1-3 “core function” words, representing a core function of a job, and between 1-3 qualifier words, which represent qualifying limitations to the core word(s). The predefined format may further include 0-1 seniority words, which represent a seniority level associated with a job position. For example, the system may determine that a job title “Beginning Network Computer Systems Monitoring and Supervising Engineer” fails to meet the pre-processing criteria, based on including too many words in the job title. In addition, or in the alternative, the system may determine that the job title fails to meet the pre-processing criteria based on including too many words classified as “qualifier words” by the system (e.g., “beginning,” “network,” “computer systems,” “monitoring,” and “supervising”).

In one or more embodiments, determining whether the seed statement meets the pre-processing criteria includes determining whether the words in the seed statement are selected from among a dictionary of authorized words. For example, rules may specify that a job title must use the term “entry-level” for any job postings requiring 0-1 years of experience. The system may determine that job titles with the words “new”, “junior”, “starting”, and “no experience needed”, which correspond to description content specifying 0-1 years of experience do not meet the pre-processing criteria.

In one or more embodiments, determining whether the description content meets the pre-processing criteria includes determining whether a ratio of sentences in the description content to words or phrases in the seed statement meets a predefined ratio (e.g., [sentences in description]: [words/phrases in seed statement]). For example, the system may determine that a set of description content including three sentences that corresponds to a seed statement including five words does not meet the required ratio of at least one sentence in a description for each word in the seed statement.

If the system determines that one or both of the seed statement and the description content do not meet the pre-processing criteria, the system modifies one or both of the seed statement and the description content (Operation 206). For example, the system may modify a seed statement to add or remove words to include a particular number of words, or to include only words that are authorized to be used. The system may modify the seed statement to meet grammatical norms. For example, if a phrase is translated from one language into English, the positioning of an adjective relative to the noun it describes may be abnormal in English. The system may reorder the words according to English grammar.

In some examples, a system may store in a database a set of organization-authorized seed statements, such as a set of authorized job titles that may be used for job postings associated with a particular company. Based on determining that a particular job title is not among the set of authorized job titles, the system may identify an authorized job title to replace the original job title. For example, job titles that correspond to the prescribed format may include: Mid-Level Marketing Consultant, Entry Level Database Engineer, Senior Legal Counsel, and Senior Clinical Research Scientist. Examples of job titles that may not correspond to the prescribed format (above) include “Experienced Marketer,” “Beginning Database Programmer,” “Senior Lawyer,” and “Experienced Clinical Expert.”

In one embodiment, the system applies a nearest-neighbor algorithm to identify a candidate replacement seed statement for replacing an original seed statement. For example, a system generates a set of vectors by encoding authorized seed statements for a particular organization, such as a set of organization-approved job titles or product titles. The system also encodes the unauthorized seed statement as a vector. The unauthorized seed statement may be, for example, a job title or product title that is not among a list of organization-approved job titles or product titles. The system maps the vectors in an n-dimensional space. The system applies the nearest-neighbor type algorithm to determine the closest authorized seed statement to the unauthorized seed statement based on a distance from a vector representing the unauthorized seed statement to the vector representing the authorized seed statement. The system replaces the unauthorized seed statement with the authorized seed statement.

In one or more embodiments, the system encodes the text as vectors by applying an algorithm, such as a term frequency-inverse document frequency (TF-IDF) to generate a numerical value for each word in the seed statement. According to one or more alternative embodiments, the system may encode the text as vectors by applying a word embedding model, such as a Word2Vec or GloVe model. According to yet another alternative embodiment, the system may encode the text as vectors by applying a pre-trained language model, such as a Bidirectional Encoder Representations from Transformers (BERT) model or a generative AI model, such as a generative pre-trained transformer (GPT) model.

The system generates a set of input segments from the seed statement (Operation 208). In one or more embodiments, the system groups words in a seed statement into input segments based on semantic content of the words in the seed statement. For example, the system may generate four input segments corresponding to one seed statement including four words, based on the context of the words in the seed statement. The system may generate three input segments corresponding to another seed statement including four words based on the context of the words in the seed statement. The system may apply a natural language processing-type machine learning model to the input segment to identify the semantic relationships among the words. The system may apply a Word2Vec model to a seed statement to encode the seed statement as a vector. The system may group one or more words into respective input segments based on numerical vector values associated with the words. Alternatively, the system may apply a set of rules to the seed statement to categorize words in the statement. For example, the system may store a dictionary of core-function words and qualifier words. The system may group words into input segments by comparing words in the seed statement to the dictionary of core-function words and qualifier words.

In one embodiment, the system generates input segments by (a) identifying a core word or set of words as one input segment, and (b) combining the core word(s) with one or more additional words to generate additional input segments. For example, a seed statement including four words may comprise the following three input segments: Segment 1 (core segment): Words 2 and 3, Segment 2 (first qualifier segment): Word 4+Words 2 and 3, Segment 3 (second qualifier segment): Word 1 (qualifier word)+Word 4+Words 2 and 3. In this example, one input segment, referred to as the core input segment, includes two words from the seed statement. Another input segment, referred to as a first qualifier input segment, includes (a) the two words from the core input segment, plus (b) an additional qualifier word. The third input segment, referred to as the second qualifier segment, includes (a) the two words from the core input segment, (b) the additional word from the first qualifier segment, plus (c) an additional qualifier word. As an example, a job description may include the terms “Senior Software Engineer-Databases.” The system may generate the following input segments: Core input segment: “Software Engineer”; First qualifier segment: “Software Engineer-Databases”; Second qualifier segment: “Senior Software Engineer”.

The system further generates a set of output segments from the description content (Operation 210). In one embodiment, the set of output segments comprise a set of sentences. The system may apply a set of rules to generate the output segments. The set of rules specify that when the description content includes sentences, a corresponding output segment includes at least one sentence. In some examples, the description content includes phrases or sentence fragments that may not be part of a sentence grammatical unit. For example, description content may include a list of items or phrases that lacks the grammatical structure of a sentence. The system may combine words, phrases, and sentence fragments, which are not part of existing sentences in the description content, into a single output segment. For example, each item on a list may be designated as part of the same output segment. In addition, the set of rules may specify that each output segment is mutually exclusive of each other output segment.

In one embodiment, the system generates output segments based on a number of characters in a sentence or set of sentences. For example, the system may apply a set of rules specifying that the system combines sentences into one output segment until the output segment includes at least 100 characters. In another embodiment in which a number of sentences in the description content exceeds a threshold, the system divides the description content into groups of sentences, such as pairs of adjacent sentences.

As discussed above, in one embodiment, the system generates the description content by applying a generative AI machine learning model to the seed statement. According to one embodiment, the system generates the set of input segments prior to providing the seed statement to the generative AI model. The system may provide the seed statement to the generative AI model with a prompt and/or metadata specifying that the output description content should include at least one sentence per input segment of the seed statement. For example, if the seed statement includes six words the system has generated four input segments from the seed statement, the system may provide the generative AI model with a prompt specifying that the output description content should include one output segment per input segment. The system may specify that one output segment should include at least 100 characters among one or more sentences. Alternatively, the system may prompt the generative AI model to generate two or more output segments per input segment. According to another example, the system may provide the generative AI model with a prompt specifying that the output description content should include a range of output segments per input statement (such as 1-3 output segments per input segment) or a number or range of output segments that is based on a type of input segment.

According to one example, the system provides the generative AI model with a prompt to specify a different number of output segments for different types of input segments. For example, the system may identify a core-function input segment and one or more qualifier segments generated from a seed statement. In the example of a job description “Lift Operations Supervisor,” the system may identify “Lift Operations” as a core-function input segment and “Supervisor” as a qualifier for an input segment “Lift Operations Supervisor”. The system may provide the generative AI model with a prompt including metadata instructing the generative AI model to generate two sentences describing the core-function input segment “Lift Operations” and one sentence describing the qualifier input segment “Lift Operations Supervisor.”

The system generates a relevance score for each input segment/output segment pair (Operation 212). For example, the system relevance score may be a similarity score based on a vector representing the input segment and a vector representing the output segment.

In one embodiment, the system generates a vector representing an input segment and a vector representing an output segment by applying a text transformer model to the input segments and the output segments. In one or more embodiments, applying a text transformer model includes tokenizing an input sentence or sequence of words into word or sub-word level tokens. Tokens are the smallest unit of text that the system divides the text content into for generating vectors. In one embodiment, the system divides the input segments and output segments into word-sized tokens (e.g., single words). The system converts the tokens into vector representations by passing the tokens though an embedding layer. The system applies a transformer encoder to the token embeddings to capture contextual and positional information of the token within a sentence or sequence of words. A resulting vector representing a sentence or sequence of words includes numerical values representing text content of tokens in a sentence or sequence of words as well as the contextual and positional information corresponding to the tokens.

According to one example embodiment, the system determines the relevance score by calculating a cosine similarity value between a vector representing an input segment and a vector representing an output segment. The system may calculate the cosine similarity value by applying the following formula:

Cos Similarity (A, B)=(A·B)/(∥A∥*∥B∥)

In the formula above, (A·B) represents the dot product of the two vectors, and ∥A∥ and ∥B∥ represent the magnitudes, or the Euclidean norms, of vectors A and B, respectively. The cosine similarity value may be a value that ranges from 0 to 1, where 0 indicates two values are extremely dissimilar, and 1 indicates the two values are the same.

According to another example embodiment, the system determines the relevance score by calculating a Jaccard similarity value between a vector representing an input segment and a vector representing an output segment. The system may calculate the Jaccard similarity value by applying the following formula:

Jaccard Similarity (A, B)=|A∩B|/|A∪B|

In the formula above, |A∩B| represents the size of the intersection of the sets A and B, and |A∪B| represents the size of the union of the sets.

According to yet another example embodiment, the system may determine the relevance score by calculating a Euclidian distance between a vector representing an input segment and a vector representing an output segment. The system may calculate the Euclidian distance by mapping vectors representing input segments and output segments in n-dimensional space, where n represents a sum of all the features that comprise the vectors mapped in the n-dimensional space. The system may calculate the Euclidian distance by applying the following formula:

Euclidean Distance (A, B)=∥A−B∥

In the formula above, ∥A−B∥ represents the Euclidean distance between vectors A and B. Smaller distances indicate higher similarity. A Euclidian distance value based on the formula above is a positive value. However, there is no limit to the magnitude of the value.

According to yet another example embodiment, the system may determine the relevance score by calculating a Manhattan distance between a vector representing an input segment and a vector representing an output segment. The system may calculate the Manhattan distance by applying the following formula:

Manhattan Distance (A, B)=Σ|A[i]−B[i]| for i=1 to n

In the formula above, A [i] and B [i] represent the ith elements of vectors A and B, and n is the dimension of the vectors.

In one or more embodiments, generating the relevance score for each input segment/output segment pair includes generating a matrix. For example, the matrix may include a bipartite graph. One vertex of the graph includes the input segments, while the other vertex of the graph includes the output segments. Intersections of the vertices store the relevance scores corresponding to the respective input segments and output segments.

For example, a system may divide a seed statement into three input segments, IS1, IS2, and IS3. The system may divide description content into five output segments OS1, OS2, OS3, OS4, and OS5. The system generates eight vectors representing the input segments and output segments, respectively. The system performs similarity determination operations to generate a relevance score for each pair: IS1, OS1; IS1, OS2; IS1, OS3; IS1, OS4; IS1, OS5; IS2, OS1; IS2, OS2; IS2, OS3; IS2, OS4; IS2, OS5; IS3, OS1; IS3, OS2; IS3, OS3; IS3, OS4; and IS3, OS5.

The system determines whether the set of generated relevance scores corresponding to the pairs of input segments and output segments meets relevance criteria (Operation 214). The criteria may include a minimum relevance score value for each input segment. For example, the criteria may specify that the input segments must each correspond to at least one unique output segment with a relevance score for the input segment/output segment pair that exceeds a threshold.

According to one or more embodiments, the system applies a maximal matching algorithm to a bipartite graph defined by the set of input segments along one vertex and the set of output segments along the other vertex. The bipartite graph comprises edges where each input segment connects to each respective output segment. In the bipartite graph, edges do not connect input segments to each other, and edges do not connect output segments to each other.

The process of performing maximal matching on the matrix of input segments and output segments results in a maximum composite relevance value. The composite relevance value is a sum of relevance values for input segment/output segment pairs. By way of example, in the embodiment described above in which there is a set of three input segments IS1, IS2, and IS3, and a set of five output segments OS1-OS5, each input segment corresponds to five relevance scores associated, respectively, with the five output segments. The maximal matching process identifies the pairing of input segments to output segments (e.g., IS1/OS2, IS2/OS4, IS3/OS1) that results in the highest combined relevance value, where no two input segments are paired with the same output segment.

For example, the relevance values for one set of pairs may include IS1/OS1: 0.45, IS2/OS2: 0.25, IS3/OS3: 0.35. The sum of relevance values is: 0.45+0.25+0.35=1.05. The relevance values for another set of pairs may be as follows: IS1/OS2: 0.35, IS2/OS3: 0.55, IS3/OS5: 0.30. The sum of relevance values is: 0.35+0.55+0.30=1.20. The relevance values for yet another set of pairs may be as follows: IS1/OS1: 0.45, IS2/OS3: 0.65, IS3/OS5: 0.30. The sum of the relevance values is: 0.45+0.65+0.30=1.40. The system performs maximal matching by finding the sum of relevance values for each input segment/output segment pair in the matrix. Only three examples are provided above, for purposes of description. Based on these three examples, the system may determine that the third example is the maximal match. The system makes the determination based on determining that the sum of relevance values (1.40) is higher than the sum of every other combination of relevance values for every other combination of input segment/output segment pairs in the bipartite graph.

Once the system identifies the set of input segment/output segment pairs corresponding to the maximal match, the system compares one or more relevance values in the maximal match to a threshold to determine if the relevance scores meet the relevance criteria. According to one embodiment, the threshold includes a numerical value for the sum of relevance scores associated with the maximal match. For example, the system may set a threshold at 1.2 for a set of three input segments. If the composite relevance score (e.g., the sum of relevance scores) corresponding to the set of input segment/output segment pairs corresponding to the maximal match meets the threshold, the system may determine that the set of relevance scores meets the relevance criteria. If the composite relevance score corresponding to the set of input segment/output segment pairs corresponding to the maximal match does not meet the threshold, the system may determine that the set of relevance scores does not satisfy the relevance criteria.

According to another example embodiment, the threshold may be set at a particular value for each input segment/output segment pair. For example, the system may set a threshold at 0.5 for each input segment/output segment pair. In the example above in which the maximal match corresponds to a set of relevance scores: 0.45, 0.65, 0.30, the system may determine that two of the relevance scores do not meet the threshold, and therefore the set of relevance scores does not satisfy the relevance criteria.

In one embodiment, the system sets a lowest relevance score among a set of relevance scores corresponding to a set of input segment/output segment pairs of a maximal match as a content match metric value. The system compares the content match metric value to the threshold to determine whether the relevance scores satisfy the relevance criteria. In the example above in which the maximal match corresponds to a set of relevance scores: 0.45, 0.65, 0.30, the system may determine that the content match metric is 0.30 (e.g., the lowest relevance score among the set of relevance scores). Based on determining the threshold is 0.5, the system determines that the content match metric does not meet the threshold and therefore the set of relevance scores does not meet the relevance criteria.

According to another example embodiment, the threshold may be set at different values for different input segment/output segment pairs. For example, the relevance criteria may specify that an input segment/output segment pair that includes an input segment identified as a “core function” input segment (or a high priority segment) requires a relevance score of at least 0.60. The relevance criteria may further specify that an input segment/output segment pair that includes an input segment identified as a “qualifier” input segment requires a relevance score of at least 0.30. In the example above in which the maximal match corresponds to a set of relevance scores: 0.45, 0.65, 0.30, the system may determine that the second relevance score corresponds to the “core function” input segment and the other relevance scores correspond to “qualifier” input segments. Accordingly, the system determines that the set of relevance scores satisfies the relevance criteria.

According to yet another embodiment, the relevance criteria may specify thresholds for both the sum of relevance scores and the relevance scores corresponding to the input segment/output segment pairs. For example, the relevance criteria may specify that the sum of relevance scores must meet one threshold (e.g., at least 1.40), and the corresponding relevance scores for the input segment/output segment pairs must meet another threshold (e.g., at least 0.40).

According to one embodiment, the system sets a threshold, or combination of thresholds, according to a type of content being analyzed. For example, a system may compare a set of relevance scores to a first set of thresholds when the text content corresponding to the relevance scores is kept internal to the organization. The system may compare a set of relevance scores to a second set of thresholds that are higher than the first set of thresholds when the text content corresponding to the relevance scores is public or external to the organization.

If the system determines that the set of relevance scores does not meet the relevance criteria, the system modifies the description content based on the relevance scores (Operation 216). For example, the system may provide one or more sentences from the existing description content to a generative AI model with a prompt to generate one or more new sentences. The prompt may specify semantic content corresponding to a particular input segment.

Referring to the example above in which the maximal match corresponds to a set of input segments/output segments and relevance scores: IS1/OS1: 0.45, IS2/OS3: 0.65, IS3/OS5: 0.30, the system may generate one prompt including (a) one or more sentences corresponding to output segment 1 (OS1), (b) one or more words corresponding to input segment 1 (IS1), and (c) an instruction to rewrite the one or more sentences to more closely correlate to the context associated with input segment 1 (IS1). Similarly, the system may generate another prompt including (a) one or more sentences corresponding to output segment 5 (OS5), (b) one or more words corresponding to input segment 3 (IS3), and (c) an instruction to rewrite the one or more sentences to more closely correlate to the context associated with input segment 3 (IS3).

According to another example, the system may generate an alternative seed statement instead of generating additional and/or different description content. The system may apply a nearest neighbor algorithm to the original seed statement and a set of historical seed statements to identify a closest historical seed statement to generate a new set of description content. The system may return the alternative seed statement and new description content to a user in response to a request. The system may indicate that the initial request could not be completed with the initial seed statement. The system may notify the user that the initial seed statement was replaced with the alternative seed statement to generate the description content.

According to yet another example, the system may generate a set of weight values corresponding to a set of relevance scores for each input segment/output segment pair in a maximal match. The system may provide a set of sentences corresponding to the maximal match pairs to a content-generation machine learning model (such as a GPT LLM). The system may further prompt the content-generation ML model with the weight values for each sentence in the set of sentences. The weight values may be provided as metadata to direct the ML model to instruct the ML model regarding to what extent the model should modify the corresponding sentence to generate a modified sentence.

The system may iteratively perform the processes of (a) generating output segments from description content (Operation 210), (b) generating relevance scores (Operation 212), (c) determining whether the relevance scores meet a set of relevance criteria (Operation 214), and (d) re-writing one or more sentences of description content until the system determines that the relevance scores meet the relevance criteria.

Based on determining that the relevance scores meet the relevance criteria, the system generates a filtered set of output segments (Operation 218). The filtered set of output segments may include a predefined number of output segments, that satisfied the relevance criteria, for each input segment. For example, the system may divide description content into output segments by generating an output segment, non-overlapping with any other output segment, of one or more complete sentences totaling 50 characters or more. In other words, if a sentence totals 40 characters, it is combined with an adjacent sentence to form an output segment. The system may generate the filtered set of output segments by selecting a set number (e.g., one, two, three, etc.) of output segments per input segment. The system may generate the filtered set of output segments by selecting different numbers of output segments corresponding to different input segments. For example, the system may select two output segments for an input segment classified as a “core functionality” input segment. The system may select one output segment for any other input segments.

The system generates a filtered set of description content from the filtered set of output segments (Operation 220). According to one example, the system may generate the filtered set of description content by arranging the sentences from the filtered set of output segments in a paragraph format. In addition, the system may analyze the filtered set of description content (e.g., sentences) to determine whether the filtered set complies with grammatical criteria. For example, omitting one or more sentences from the initial description content may result in text that lacks transition language or context for remaining sentences. The system may modify the filtered set of sentences to comply with the grammatical criteria. According to one example, the system provides the filtered set of sentences to a generative AI model with a prompt to re-write the sentences to comply with grammatical criteria.

According to one embodiment, generating the filtered set of description content includes generating one or more additional sentences. For example, the process of filtering the description content based on relevance criteria may result in filtering the description content from ten sentences down to four sentences. However, a system may require that a particular set of content (such as a job posting or product description) include at least six sentences of description content. Accordingly, the system may provide the filtered set of description content (e.g., four sentences) to a generative AI model with a prompt to generate two additional sentences. The prompt may further specify one or more input segments to which the additional sentences should be directed.

One or more embodiments include iteratively (a) generating output segments (Operation 210), (b) generating relevance scores for input segment/output segment pairs (Operation 212), including output segments corresponding to newly-generated sentences, (c) determining whether relevance scores meet relevance criteria (Operation 214), (d) generating filtered sets of output segments (Operation 218), and (e) generating filtered sets of description content (Operation 220), including any new sentences based on description content length criteria until the filtered set of description content, or sentences, meets both length and relevance criteria.

In an embodiment in which the system generates the description content based on receiving a user-generated request including the seed statement, the system sends the filtered set of description content to a user device rather than sending the initially-generated description content to the user device.

### 4. Example Embodiment

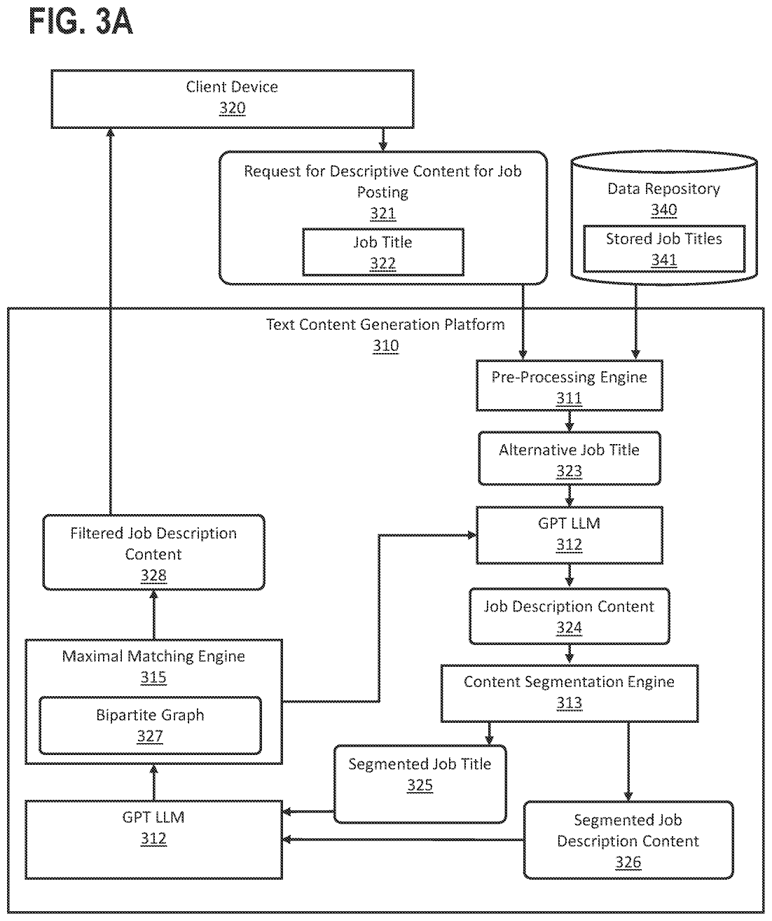

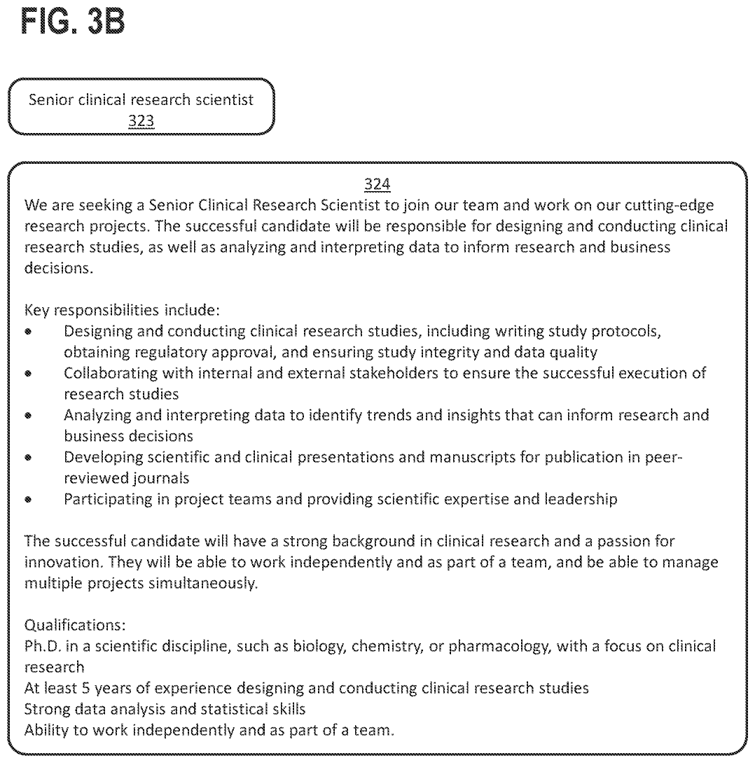

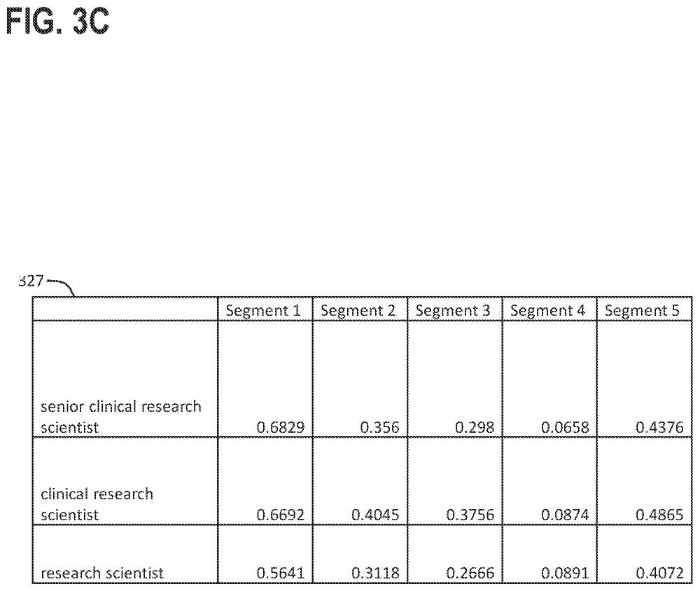

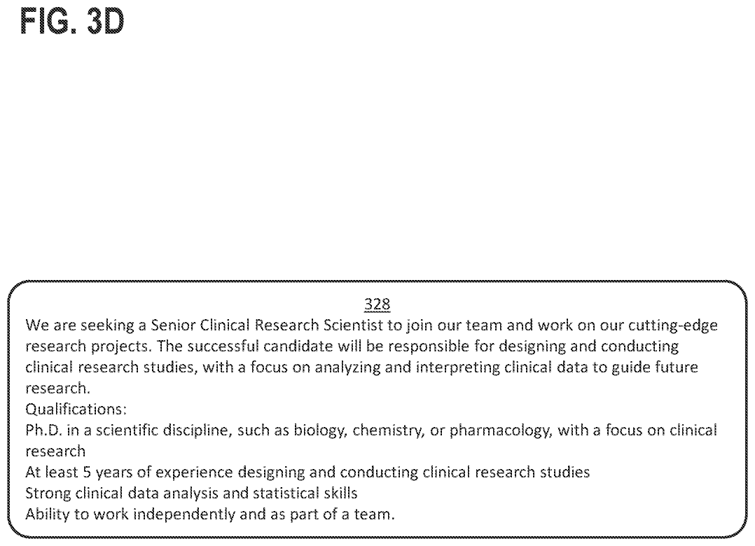

FIG. 3 illustrates a detailed example for purposes of clarity. Components and/or operations described below should be understood as one specific example that may not be applicable to certain embodiments. Accordingly, components and/or operations described below should not be construed as limiting the scope of any of the claims.

A text content generation platform 310 receives a request 321 from a client device 320 to generate descriptive content for a job posting. The request 321 includes a job title 322. In the example embodiment of FIG. 3, the job title is “Scientist for Clinical Research, Supervisor.” The text content generation platform 310 includes a pre-processing engine 311. The pre-processing engine analyzes the job title 322 included in the request 321 to determine whether the job title 322 meets a set of description-generation criteria. The description-generation criteria are generated and managed by an entity, such as a company that manages the publication of job postings.

The pre-processing engine 311 determines that the job title 322 does not meet the description-generation criteria. For example, the description-generation criteria specify the following format for job postings: [seniority qualifier] [qualifier (one or more)] [core functionality]. In addition, the description-generation criteria specify that particular terms may be used in job postings, as indicated by a set of stored job titles 341 stored in a data repository 340.

The pre-processing engine 311 generates a vector of the job title 322 and vectors of stored job titles 341 by applying a Word2Vec model to the words in the job title 322 and job titles 341. The pre-processing engine 311 determines a Euclidian distance, measured in an n-dimensional space corresponding to a number of features in the vectors, between the vector representing the job title 322 and each of the vectors corresponding to the stored job titles 341 to identify an alternative job title 323 among the stored job titles 341 that most closely matches the job title 322. In the example of FIG. 3, the alternative job title 323 is “Senior Clinical Research Scientist.” The text content generation platform 310 transmits the alternative job title 323 to the client device 320 for approval prior to generating the description content for the job title.

The text content generation platform 310 provides the alternative job title 323 to the generative AI model 312 to generate text description content corresponding to job title 323. The generative AI model 312 is a transformer-type model that generates text content from a set of seed text. In the example of FIG. 3, the generative AI model 312 is a generative pre-trained transformer (GPT) large language model (LLM).

In the example embodiment of FIG. 3, the text content generation platform 310 generates a prompt: “Create a job posting for the position of Senior Clinical Research Scientist at the company ABCDEFG Co.” The GPT LLM 312 generates job description content 324 based on the prompt. FIG. 3B illustrates an example of the alternative job title 323 and the corresponding job description 324 generated by the GPT LLM 312.

A content segmentation engine 313 segments the alternative job title 323 to generate a segmented job title 325. The segmented job title 325 is made up of multiple separate input segments of words. The content segmentation engine 313 segments the job description content 324 to generate segmented job description content 326. The segmented job description content 326 is made up of multiple separate output segments of one or more sentences as well as phrases that are not part of sentences in the job description content 324.

In particular, the content segmentation engine 313 generates the following output segments from the job description content 324:

Job Description Segment 1: We are seeking a Senior Clinical Research Scientist to join our team and work on cutting-edge research projects.

Job Description Segment 2: The successful candidate will be responsible for designing and conducting clinical research studies as well as analyzing and interpreting data to inform research and business decisions.

Job Description Segment 3: Key responsibilities include: Designing and conducting clinical research studies, including writing study protocols, obtaining regulatory approval, and ensuring study integrity and data quality Collaborating with internal and external stakeholders to ensure the successful execution of research studies Analyzing and interpreting data to identify trends and insights that can inform research and business decisions Developing scientific and clinical presentations and manuscripts for publication in peer-reviewed journals Participating in project teams and providing scientific expertise and leadership The successful candidate will have a strong background in clinical research and a passion for innovation.

Job Description Segment 4: They will be able to work independently and as part of a team and be able to manage multiple projects simultaneously.

Job Description Segment 5: Qualifications: Ph.D. in a scientific discipline, such as biology, chemistry, or pharmacology, with a focus on clinical research At least 5 years of experience designing and conducting clinical research studies Strong data analysis and statistical skills Ability to work independently and as part of a team.

In the example embodiment described in FIG. 3, the content segmentation engine 313 divided the job description content 324 into segments by: (a) designating a sentence with a period as a segment, and (b) combining phrases, which do not end in periods, into a same sentence until a period is encountered. For example, Job Description Segment 3 includes a phrase followed by a colon and a list comprising phrases. The list is not followed by a period. Accordingly, the content segmentation engine 313 combines the list with the subsequent sentence, beginning with “The successful candidate will . . . ”

The text content generation platform 310 generates vectors for the segmented job title 325 and the segmented job description content 326. In the example of FIG. 3, the platform 310 provides the segmented job title 325 and the segmented job description content 326 to the GPT LLM 312 to generate vectors for each segment in the segmented job title 325 and the segmented job description content 326. The generative AI model 312 is illustrated twice in FIG. 3 for purposes of displaying a sequence of operations together with elements representing the model 312. In the example embodiment of FIG. 3, both representations of the generative AI model 312 represent the same model, not two different models. However, different embodiments encompass using different models and/or algorithms to generate text content and vectors representing the text content.

A maximal matching engine 315 determines a relevance score for each input segment/output segment pair (or job title segment/job description segment, as described in FIG. 3) by calculating a cosine similarity value between a vector representing an input segment and a vector representing an output segment. The maximal matching engine 315 calculates the cosine similarity value by applying the following formula:

Cos Similarity (A, B)=(A·B)/(∥A∥*∥B∥)

In the formula above, (A·B) represents the dot product of the two vectors, and ∥A∥ and ∥B∥ represent the magnitudes, or the Euclidean norms, of vectors A and B, respectively. The cosine similarity value is a value that ranges from 0 to 1, where 0 indicates two values are extremely dissimilar, and 1 indicates the two values are the same.

The maximal matching engine 315 generates a bipartite graph 327 based on the relevance scores for the input segment/output segment pairs. FIG. 3C illustrates a bipartite graph 327 according to one embodiment. The bipartite graph 327 includes the job title segments along one vertex and the job description segments along the other vertex. The graph 327 stores the relevance score for each input segment/output segment pair at the intersection of the segments.

The maximal matching engine 315 applies a maximal matching algorithm to the bipartite graph 327 to determine the combination of job title segment/job description segment pairs that correspond to the maximum composite relevance value. In the example illustrated in FIG. 3C, the maximum composite relevance value is: Input Segment 1 (“senior clinical research scientist”)/Output Segment 1:0.6829; Input Segment 2 (“clinical research scientist”)/Output Segment 5:0.4865; Input Segment 3 (“research scientist”)/Output Segment 2:0.3118=0.6829+0.3118+0.4865=1.4812 (maximum composite relevance value).

In one or more embodiments, a process implemented by the maximal matching algorithm may include iteratively matching an input segment with an output segment based on a highest relevance score, and performing a subsequent matching while excluding from the analysis the column and row corresponding to the previously-matched input segment(s) and output segment(s). For example, referring to FIG. 3C, the relevance score 0.6829 is identified as the maximum relevance score among all the relevance scores in the bipartite graph 327. Accordingly, Segment 1 is paired with input segment “senior clinical research scientist.” The column corresponding to Segment 1 and the row corresponding to the input segment “senior clinical research scientist” are omitted from further maximal matching analysis. Among the remaining similarity scores in the bipartite graph 327, 0.4865 is the highest similarity score. Accordingly, Segment 5 is paired with input segment “clinical research scientist.” The corresponding row and column are omitted from subsequent matching analysis. Among the remaining similarity scores in the bipartite graph 327, 0.3118 is the highest similarity score. Accordingly, Segment 2 is paired with input segment “research scientist.”

The maximal matching engine 315 compares the lowest relevance value among the relevance values for the input segment/output segment pairs in the set of input segment/output segment pairs corresponding to the maximal match to a threshold value of 0.5 for job postings, as designated by a human resources organization. Based on determining the lowest relevance value of 0.3118 for the Input Segment 3/Output segment 2 pair does not meet the threshold, the maximal matching engine determines that the description content does not meet a relevancy criteria.

Based on determining the relevancy score associated with the second output segment does not meet the relevancy criteria of 0.5, the maximal matching engine 315 provides the sentence included in the second output segment (“The successful candidate will be responsible for designing and conducting clinical research studies as well as analyzing and interpreting data to inform research and business decisions.”) to the GPT LLM 312 with a prompt to generate a new sentence based on the previous sentence, with an increased relevance to the content of the third input segment (“research scientist”). Similarly, the maximal matching engine 315 provides the sentence included in the fifth output segment (“′Qualifications: Ph.D. in a scientific discipline, such as biology, chemistry, or pharmacology, with a focus on clinical research At least 5 years of experience designing and conducting clinical research studies Strong data analysis and statistical skills Ability to work independently and as part of a team”) to the GPT LLM 312 with a prompt to generate a new sentence based on the previous sentence, with an increased relevance to the content “clinical research scientist.” The text content generation platform 310 may iteratively (a) generate job description segments, (b) encode the segments as vectors, (c) perform maximal matching based on relevancy scores, and (d) provide sentences to the GPT LLM 312 for re-writing until the relevancy score for each output segment among the input segment/output segment pairs corresponding to the maximal matching sets of pairs meets the threshold of 0.5.

Based on determining the input segment/output segment pairs of the set of maximal matching pairs meets the threshold of 0.5, the maximal matching engine 315 generates filtered job description content 328 from the original job description content 324. The filtered job description content includes only the sentences corresponding to the output segments included in the maximal matching sets of input segment/output segment pairs. FIG. 3D illustrates an example of filtered job description content generated based on an iterative process of (a) generating job description segments, (b) encoding the segments as vectors, (c) performing maximal matching based on relevancy scores, and (d) providing sentences to the GPT LLM 312 for re-writing. For example, based on the iterative process above, the text content generation platform 310 identified the sentence “The successful candidate will be responsible for designing and conducting clinical research studies, as well as analyzing and interpreting data to inform research and business decisions.” as being among a set of maximal matching output segments. Based on determining the sentence did not meet a relevance threshold, the text content generation platform 310 applied the GPT LLM 312 to the sentence for re-writing until the resulting sentence (“The successful candidate will be responsible for designing and conducting clinical research studies, with a focus on analyzing and interpreting clinical data to guide future research.”) met the relevancy threshold. The text content generation platform 310 returns the filtered job description content 328 to the client device 320 in response to the request for descriptive content 321.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QOS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

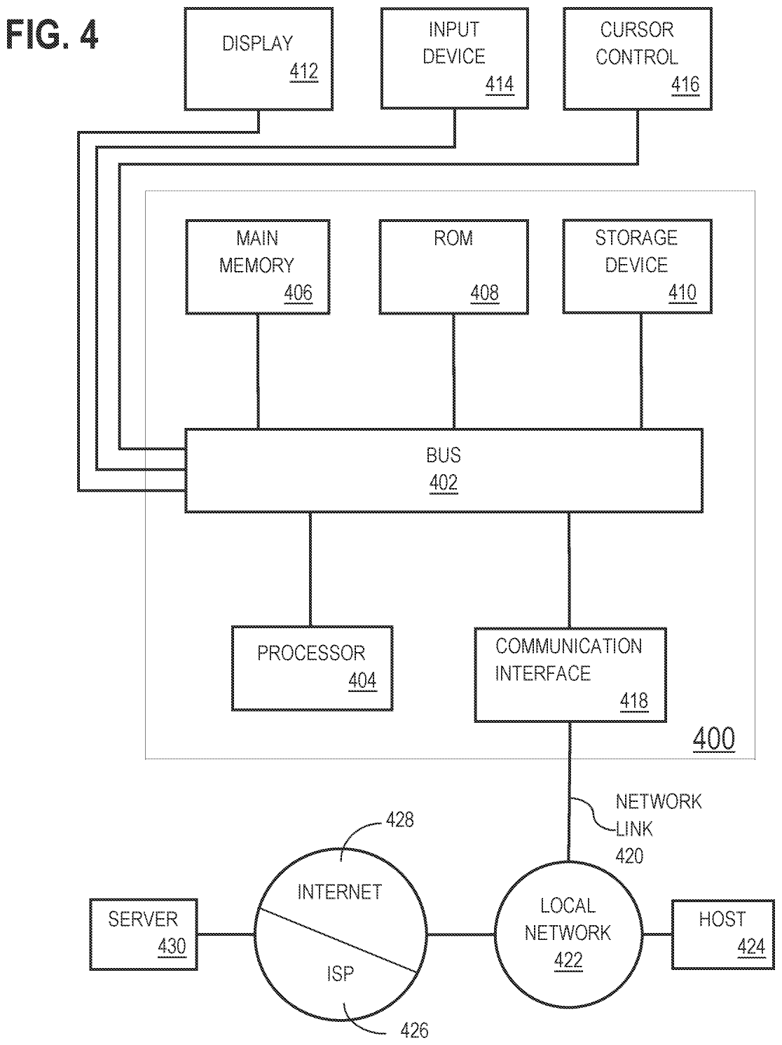

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the: process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic, or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, causes performance of operations comprising:
receiving a request comprising a first input to a generative AI model;
applying a generative AI model to the first input to obtain first output generated by the generative AI model;
generating a plurality of input subsets based on the first input, each of the plurality of input subsets comprising respective subsets of the first input;
generating a plurality of output subsets based on the first output, each of the plurality of output subsets comprising respective subsets of the first output;
computing a plurality of similarity values based on the plurality of input subsets and the plurality of output subsets, each of the plurality of similarity values representing a similarity between one of the plurality of input subsets and one of the plurality of output subsets;
based on the plurality of similarity values, filtering out one or more of the plurality of output subsets to generate a reduced plurality of output subsets;
generating a response, to the request, based on the reduced plurality of output subsets; and
transmitting the response in response to the request.

2. The one or more non-transitory computer readable media of claim 1, wherein filtering out one or more of the plurality of output subsets based on the plurality of similarity values comprises:
determining for each of the plurality of input subsets, a highest-ranked output subset of the plurality of output subsets; and
retaining within the reduced plurality of output subsets: output subsets, of the plurality of output subsets, that correspond to the highest-ranked output subset for at least one of the plurality of input subsets.

3. The one or more non-transitory computer readable media of claim 1, wherein filtering out one or more of the plurality of output subsets based on the plurality of similarity values comprises:
determining for each of the plurality of input subsets, a highest-ranked output subset of the plurality of output subsets; and
identifying the one or more of the plurality of output subsets to be filtered out as output subsets, of the plurality of output subsets, that are not the highest-ranked output subset for at least one of the plurality of input subsets.

4. The one or more non-transitory computer readable media of claim 1, wherein filtering out one or more of the plurality of output subsets based on the plurality of similarity values comprises:
for each particular output subset of the plurality of output subsets:
determining a highest similarity value of the similarity values computed for the particular output subset in relation to each of the plurality of input subsets; and
including the particular output subset in the one or more of the plurality of output subsets to be filtered out based on the highest similarity value not meeting a threshold value.

5. The one or more non-transitory computer readable media of claim 1, wherein filtering out one or more of the plurality of output subsets based on the plurality of similarity values comprises:
applying a maximal matching algorithm to the plurality of similarity values;
based on applying the maximal matching algorithm, identifying a set of input subset-output subset pairs corresponding to a maximal match; and
filtering out each output subset that is not among the set of input subset-output subset pairs.

6. The one or more non-transitory computer readable media of claim 1, wherein generating the response based on the reduced plurality of output subsets comprises:
computing a weight associated with each particular output subset of the reduced plurality of output subsets based on one or more of the similarity values generated for the particular output subset in relation to respective input subsets; and
applying the reduced plurality of output subsets with respective weights to a response generation model to generate the response.

7. The one or more non-transitory computer readable media of claim 1, wherein, filtering out the one or more of the plurality of output subsets to generate the reduced plurality of output subsets comprises:
filtering out all of the plurality of output subsets based on determining that the plurality of similarity values fail to meet a particular threshold;
responsive to determining that the plurality of similarity values fail to meet a particular threshold: generating an alternative input based on the first input;
applying the generative AI model to the alternative input to obtain a second output generated by the generative AI model;
generating a second plurality of input subsets based on the alternative input;
generating a second plurality of output subsets based on the second output, each of the plurality of output subsets comprising respective subsets of the first output;
determining a second plurality of similarity values based on the second plurality of input subsets and the second plurality of output subsets; and
generating a second reduced plurality of output subsets based on the second plurality of similarity values,
wherein generating the response comprises generating the response to the request based on the second reduced plurality of output subsets.

8. A method, comprising:
receiving a request comprising a first input to a generative AI model;
applying a generative AI model to the first input to obtain first output generated by the generative AI model;
generating a plurality of input subsets based on the first input, each of the plurality of input subsets comprising respective subsets of the first input;
generating a plurality of output subsets based on the first output, each of the plurality of output subsets comprising respective subsets of the first output;
computing a plurality of similarity values based on the plurality of input subsets and the plurality of output subsets, each of the plurality of similarity values representing a similarity between one of the plurality of input subsets and one of the plurality of output subsets;
based on the plurality of similarity values, filtering out one or more of the plurality of output subsets to generate a reduced plurality of output subsets;
generating a response, to the request, based on the reduced plurality of output subsets; and
transmitting the response in response to the request.

9. The method of claim 8, wherein filtering out one or more of the plurality of output subsets based on the plurality of similarity values comprises:
determining for each of the plurality of input subsets, a highest-ranked output subset of the plurality of output subsets; and
retaining within the reduced plurality of output subsets: output subsets, of the plurality of output subsets, that correspond to the highest-ranked output subset for at least one of the plurality of input subsets.

10. The method of claim 8, wherein filtering out one or more of the plurality of output subsets based on the plurality of similarity values comprises:
determining for each of the plurality of input subsets, a highest-ranked output subset of the plurality of output subsets; and
identifying the one or more of the plurality of output subsets to be filtered out as output subsets, of the plurality of output subsets, that are not the highest-ranked output subset for at least one of the plurality of input subsets.

11. The method claim 8, wherein filtering out one or more of the plurality of output subsets based on the plurality of similarity values comprises:
for each particular output subset of the plurality of output subsets:
determining a highest similarity value of the similarity values computed for the particular output subset in relation to each of the plurality of input subsets; and
including the particular output subset in the one or more of the plurality of output subsets to be filtered out based on the highest similarity value not meeting a threshold value.

12. The method of claim 8, wherein filtering out one or more of the plurality of output subsets based on the plurality of similarity values comprises:
applying a maximal matching algorithm to the plurality of similarity values;
based on applying the maximal matching algorithm, identifying a set of input subset-output subset pairs corresponding to a maximal match; and
filtering out each output subset that is not among the set of input subset-output subset pairs.

13. The method of claim 8, wherein generating the response based on the reduced plurality of output subsets comprises:
computing a weight associated with each particular output subset of the reduced plurality of output subsets based on one or more of the similarity values generated for the particular output subset in relation to respective input subsets; and
applying the reduced plurality of output subsets with respective weights to a response generation model to generate the response.

14. The method of claim 8, wherein, filtering out the one or more of the plurality of output subsets to generate the reduced plurality of output subsets comprises:
filtering out all of the plurality of output subsets based on determining that the plurality of similarity values fail to meet a particular threshold;
responsive to determining that the plurality of similarity values fail to meet a particular threshold: generating an alternative input based on the first input;
applying the generative AI model to the alternative input to obtain a second output generated by the generative AI model;
generating a second plurality of input subsets based on the alternative input;
generating a second plurality of output subsets based on the second output, each of the plurality of output subsets comprising respective subsets of the first output;
determining a second plurality of similarity values based on the second plurality of input subsets and the second plurality of output subsets; and
generating a second reduced plurality of output subsets based on the second plurality of similarity values,
wherein generating the response comprises generating the response to the request based on the second reduced plurality of output subsets.

15. A system comprising:
one or more processors; and
memory storing instructions that, when executed by the one or more processors, cause the system to perform operations comprising:
receiving a request comprising a first input to a generative AI model;
applying a generative AI model to the first input to obtain first output generated by the generative AI model;
generating a plurality of input subsets based on the first input, each of the plurality of input subsets comprising respective subsets of the first input;
generating a plurality of output subsets based on the first output, each of the plurality of output subsets comprising respective subsets of the first output;
computing a plurality of similarity values based on the plurality of input subsets and the plurality of output subsets, each of the plurality of similarity values representing a similarity between one of the plurality of input subsets and one of the plurality of output subsets;
based on the plurality of similarity values, filtering out one or more of the plurality of output subsets to generate a reduced plurality of output subsets;
generating a response, to the request, based on the reduced plurality of output subsets; and
transmitting the response in response to the request.

16. The system of claim 15, wherein filtering out one or more of the plurality of output subsets based on the plurality of similarity values comprises:
determining for each of the plurality of input subsets, a highest-ranked output subset of the plurality of output subsets; and
retaining within the reduced plurality of output subsets: output subsets, of the plurality of output subsets, that correspond to the highest-ranked output subset for at least one of the plurality of input subsets.

17. The system of claim 15, wherein filtering out one or more of the plurality of output subsets based on the plurality of similarity values comprises:
determining for each of the plurality of input subsets, a highest-ranked output subset of the plurality of output subsets; and
identifying the one or more of the plurality of output subsets to be filtered out as output subsets, of the plurality of output subsets, that are not the highest-ranked output subset for at least one of the plurality of input subsets.

18. The system of claim 15, wherein filtering out one or more of the plurality of output subsets based on the plurality of similarity values comprises:
for each particular output subset of the plurality of output subsets:
determining a highest similarity value of the similarity values computed for the particular output subset in relation to each of the plurality of input subsets; and
including the particular output subset in the one or more of the plurality of output subsets to be filtered out based on the highest similarity value not meeting a threshold value.

19. The system of claim 15, wherein filtering out one or more of the plurality of output subsets based on the plurality of similarity values comprises:
applying a maximal matching algorithm to the plurality of similarity values;
based on applying the maximal matching algorithm, identifying a set of input subset-output subset pairs corresponding to a maximal match; and
filtering out each output subset that is not among the set of input subset-output subset pairs.

20. The system of claim 15, wherein generating the response based on the reduced plurality of output subsets comprises:
computing a weight associated with each particular output subset of the reduced plurality of output subsets based on one or more of the similarity values generated for the particular output subset in relation to respective input subsets; and
applying the reduced plurality of output subsets with respective weights to a response generation model to generate the response.
